(19) United States
(12) Patent Application Publication
(10) Pub. No.: US 2009/0035489 A1
(43) Pub. Date: Feb. 5, 2009

(54) INK JET RECORDING MEDIUM

(75) Inventor: Hideki KAIMOTO, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Tokyo (JP)

(21) Appl. No.: 12/182,638

(22) Filed: Jul. 30, 2008

(30) Foreign Application Priority Data
Aug. 3, 2007 (JP) 2007-202809

(51) Int. Cl. B41M 5/00

(52) U.S. Cl. 428/32.1

(57) ABSTRACT

An ink jet recording medium is disclosed which includes, on a support, at least one ink receiving layer and a colloidal silica layer containing a cationic compound and a compound having an amine oxide group in this order.

### CROSS-REFERENCE TO RELATED APPLICATION

This application claims priority under 35 USC 119 from Japanese Patent Application No. 2007-202809, the disclosure of which is incorporated by reference herein.

### BACKGROUND OF THE INVENTION

1. Field of the Invention

The present invention relates to an ink jet recording medium.

2. Description of the Related Art

In recent years, various information processing systems have been developed accompanying the rapid development of the information industry, and recording methods and apparatuses suitable for the information systems have been also developed and brought into practical use.

Among these recording methods, ink jet recording methods have been widely used for home uses as well as business uses, because recording can be carried out on various recording materials, and hardware (apparatus) therefor is relatively low in price, compact and quiet.

In addition, the recent increase in the resolution of ink jet printers has allowed recording of high quality images with photographic-like quality. With the development of hardware (apparatus), various recording media for ink jet recording have been developed.

General requirements for properties of such an ink jet recording medium include: (1) high drying speed (high ink-absorbing speed); (2) favorable and uniform ink dot diameter (without ink bleeding); (3) favorable granularity; (4) high dot circularity; (5) high color density; (6) high color saturation (absence of dullness); (7) favorable light fastness, gas resistance, and water resistance of printed image areas; (8) high whiteness of a recording sheet; (9) favorable storage stability of a recording sheet (absence of yellowing and image bleeding after long term storage); (10) deformation resistance and favorable dimensional stability (suppressed curling); and (11) favorable traveling characteristics in an apparatus.

In addition, photographic glossy paper used for recording high quality images with so-called photographic-like quality is required to have, in addition to the above-described properties, a high glossiness, surface smoothness, and a texture similar to that of a silver halide photographic paper.

Conventionally, various ink jet recording media having a surface layer containing colloidal silica as the outermost layer have been proposed with the intention of improving scratch resistance and glossiness (for example, see Japanese Patent Application Laid-Open (JP-A) Nos. 2003-159862 and 2006-263951). The surface layer for improving the scratch resistance and glossiness is preferably formed by simultaneous multilayer coating. However, if the balance of surface tension between the upper and lower layer coating liquids is poor, the coated layer develops defects such as shrinkage, repelling, streaks, and graininess. Therefore, a surfactant is an essential component in the coating liquid for forming upper layers, and in particular, the surface layer farthest from the support.

However, when the surface layer contains colloidal silica, some surfactants used together with the colloidal silica cause aggregation during application and drying of the colloidal silica layer coating liquid, which results in a decrease in glossiness. For example, when the betaine surfactant used in JP-A No. 2003-159862 is used to make a surface layer coating liquid containing colloidal silica, the resulting glossiness is not necessarily satisfactory.

### SUMMARY OF THE INVENTION

According to an aspect of the invention, there is provided an ink jet recording medium comprising, on a support, at least one ink receiving layer and a colloidal silica layer containing a cationic compound and a compound having an amine oxide group in this order.

### DETAILED DESCRIPTION OF THE INVENTION

The ink jet recording medium of the invention includes, on a support, at least one ink receiving layer and a colloidal silica layer containing a cationic compound and a compound having an amine oxide group in this order.

As necessary, the ink jet recording medium of the present invention may further include other layers in addition to the at least one ink receiving layer and the colloidal silica layer on the support. In the structure of the ink jet recording medium of the invention, the ink receiving layer is provided on the support, and the colloidal silica layer is provided on the ink receiving layer. The colloidal silica layer is preferably a surface layer (outermost layer).

It is known that formation of a colloidal silica layer on the surface of an ink jet recording medium improves the glossiness and scratch resistance of the ink jet recording medium.

Usually, when an ink jet recording medium has a surface layer such as a colloidal silica layer, the glossiness of the medium improves provided that the colloidal silica particles are uniformly dispersed in the surface of the recording medium, but the glossiness deteriorates if the particles aggregate in the colloidal silica layer coating liquid during application and drying processes, which results in the formation of a nonuniform colloidal silica layer. According to the invention, the decrease of the glossiness of the colloidal silica layer is markedly prevented, whereby an ink jet recording medium having a high glossiness is provided.

An additional surface layer tends to cause the decrease of the image density. According to the invention, as described above, the colloidal silica layer contains a cationic compound and a compound having an amine oxide group, thereby improving the image density. The mechanism is likely that the prevention of aggregation of colloidal silica improves the surface smoothness to suppress light scattering on the surface and suppresses light scattering within the colloidal silica layer.

The components of the ink jet recording medium of the invention, such as a support and a colloidal silica layer, are described below in detail.

### <Colloidal Silica Layer>

The ink jet recording medium of the invention includes a colloidal silica layer, and the colloidal silica layer contains colloidal silica, a cationic compound, and a compound having an amine oxide group. The layer may further contain other components as necessary.

The colloidal silica layer on the ink jet recording medium imparts scratch resistance to the ink jet recording medium.

### —Colloidal Silica—

The colloidal silica is a dispersion of ultrafine silica particles in water or a polar solvent, wherein the silica particles have a particle diameter of 1 to 500 nm, and have many hydroxy groups on their surfaces, and include siloxane bonds (—Si—O—Si—) therein. Such colloidal silica is specifically described, in “Applied Technique of High Purity Silica”, supervised by Toshiro Kagami and Akira Hayashi, Chapters 4 and 5, CMC (1991), Chapter 3. Examples of commercially available products of the colloidal silica include SNOWTEX (trade name, manufactured by Nissan Chemical Industries, Ltd.) and CATALOID (trade name, manufactured by Catalysts & Chemicals Ind. Co., Ltd.)

According to the invention, the colloidal silica used in the colloidal silica layer may be a commercial product as described above. The content of colloidal silica in the colloidal silica layer is preferably from 0.1 to 3 g/m², and more preferably from 0.2 to 1 g/m².

### —Cationic Compound—

According to the invention, the colloidal silica layer contains at least one cationic compound. When the colloidal silica layer contains the cationic compound and the below-described compound having an amine oxide group, the colloidal silica has improved dispersion stability, and coloring materials such as a dye in the ink are caught, thereby improving the image density and glossiness.

The cationic compound used in the invention may be any cationic compound, and is preferably a cationic polymer or a multivalent metal salt.

### (Cationic Polymer)

The cationic polymer is preferably a polymer mordant having a primary to tertiary amino group, or a quaternary ammonium salt group as a cationic group. The cationic compound may be a cationic non-polymeric mordant.

Preferable examples of the cationic polymer include homopolymers of monomers (mordant monomers) having a primary to tertiary amino group or a salt thereof, or a quaternary ammonium salt group, and copolymers and polycondensed polymers of the mordant monomer and another monomer (hereinafter referred to as a “non-mordant monomer”). These polymers may be used in the form of a water-soluble polymer or water-dispersible latex particles.

Examples of the monomer (mordant monomer) include trimethyl-p-vinylbenzyl ammonium chloride, trimethyl-m-vinylbenzyl ammonium chloride, triethyl-p-vinylbenzyl ammonium chloride, triethyl-m-vinylbenzyl ammonium chloride, N,N-dimethyl-N-ethyl-N-p-vinylbenzyl ammonium chloride, N,N-diethyl-N-methyl-N-p-vinylbenzyl ammonium chloride, N,N-dimethyl-N-n-propyl-N-p-vinylbenzyl ammonium chloride, N,N-dimethyl-N-n-octyl-N-p-vinylbenzyl ammonium chloride, N,N-dimethyl-N-benzyl-N-p-vinylbenzyl ammonium chloride, N,N-diethyl-N-benzyl-N-p-vinylbenzyl ammonium chloride, N,N-dimethyl-N-(4-methyl)benzyl-N-p-vinylbenzyl ammonium chloride, N,N-dimethyl-N-phenyl-N-p-vinylbenzyl ammonium chloride;

trimethyl-p-vinylbenzyl ammonium bromide, trimethyl-m-vinylbenzyl ammonium bromide, trimethyl-p-vinylbenzyl ammonium sulfonate, trimethyl-m-vinylbenzyl ammonium sulfonate, trimethyl-p-vinylbenzyl ammonium acetate, trimethyl-m-vinylbenzyl ammonium acetate, N,N,N-triethyl-N-2-(4-vinylphenyl)ethyl ammonium chloride, N,N,N-triethyl-N-2-(3-vinylphenyl)ethyl ammonium chloride, N,N-diethyl-N-methyl-N-2-(4-vinylphenyl)ethyl ammonium chloride, N,N-diethyl-N-methyl-N-2-(4-vinylphenyl)ethyl ammonium acetate;

N,N-dimethylamino ethyl(meth)acrylate, N,N-diethylaminoethyl(meth)acrylate, N,N-dimethylaminopropyl(meth)acrylate, N,N-diethylaminopropyl(meth)acrylate, N,N-dimethylaminoethyl(meth)acrylamide, N,N-diethylaminoethyl(meth)acrylamide, N,N-dimethylaminopropyl(meth)acrylamide, and N,N-diethylaminopropyl(meth)acrylamide quaternized with methyl chloride, ethyl chloride, methyl bromide, ethyl bromide, methyl iodide or ethyl iodide, and sulfonates, alkyl sulfonates, acetates, and alkyl carboxylates thereof obtained by anion substitution.

Specific examples include monomethyl diallyl ammonium chloride, trimethyl-2-(methacryloyloxy)ethyl ammonium chloride, triethyl-2-(methacryloyloxy)ethyl ammonium chloride, trimethyl-2-(acryloyl oxy)ethyl ammonium chloride, triethyl-2-(acryloyloxy)ethyl ammonium chloride, trimethyl-3-(methacryloyloxy)propyl ammonium chloride, triethyl-3-(methacryloyloxy)propyl ammonium chloride, trimethyl-2-(methacryloylamino)ethyl ammonium chloride, triethyl-2-(methacryloylamino)ethyl ammonium chloride, trimethyl-2-(acryloylamino)ethyl ammonium chloride, triethyl-2-(acryloylamino)ethyl ammonium chloride, trimethyl-3-(methacryloylamino)propyl ammonium chloride, triethyl-3-(methacryloylamino)propyl ammonium chloride, trimethyl-3-(acryloylamino)propyl ammonium chloride, triethyl-3-(acryloylamino)propyl ammonium chloride;

N,N-dimethyl-N-ethyl-2-(methacryloyloxy)ethyl ammonium chloride, N,N-diethyl-N-methyl-2-(methacryloyloxy)ethyl ammonium chloride, N,N-dimethyl-N-ethyl-3-(acryloylamino)propyl ammonium chloride, trimethyl-2-(methacryloyloxy)ethyl ammonium bromide, trimethyl-3-(acryloylamino)propyl ammonium bromide, trimethyl-2-(methacryloyloxy)ethyl ammonium sulfonate, and trimethyl-3-(acryloylamino)propyl ammonium acetate.

Other examples of the copolymerizable monomer include N-vinylimidazole and N-vinyl-2-methylimidazole.

Other examples include allylamine, diallylamine, and derivatives and salts thereof. Examples of the compound include allylamine, allylamine hydrochloride, allylamine acetate, allylamine sulfate, diallylamine, diallylamine hydrochloride, diallylamine acetate, diallylamine sulfate, diallylmethylamine and salts thereof (for example, hydrochlorides, acetates, and sulfates), diallylethylamine and salts thereof (for example, hydrochlorides, acetates, and sulfates), and diallyldimethylammonium salts (examples of the counter anion of the salts include chlorides, and acetate ions, and sulfate ions). These allylamine and diallylamine derivatives have poor polymerizability in the amine form, so that they are usually polymerized in the salt form, and as necessary desalted.

Other examples include compounds obtained by polymerizing units such as N-vinylacetamide or N-vinylformamide, and then converting the units to vinylamine units by hydrolysis (and further to salts).

The non-mordant monomer refers to a monomer which has no basic or cationic moiety such as a primary to tertiary amino group or salts thereof, or a quaternary ammonium salt group, and does not interact or scarcely interacts with dyes in the ink jet ink.

Examples of the non-mordant monomer include alkyl(meth)acrylates; cycloalkyl (meth)acrylates such as cyclohexyl(meth)acrylate; aryl(meth)acrylates such as phenyl (meth)acrylate; aralkyl esters such as benzyl(meth)acrylate; aromatic vinyls such as styrene, vinyl toluene, and α-methylstyrene; vinyl esters such as vinyl acetate, vinyl propionate, and vinyl versatate; allyl esters such as allyl acetate; halogen-containing monomers such as vinylidene chloride and vinyl chloride; vinyl cyanide such as (meth)acrylonitrile; and olefins such as ethylene and propylene.

The alkyl(meth)acrylate preferably has 1 to 18 carbon atoms in the alkyl moiety, and examples of such alkyl(meth)acrylate include methyl(meth)acrylate, ethyl(meth)acrylate, propyl(meth)acrylate, isopropyl(meth)acrylate, n-butyl(meth)acrylate, isobutyl (meth)acrylate, t-butyl(meth)acrylate, hexyl(meth)acrylate, octyl(meth)acrylate, 2-ethylhexyl(meth)acrylate, lauryl(meth)acrylate, and stearyl(meth)acrylate.

Among them, methyl acrylate, ethyl acrylate, methyl methacrylate, ethyl methacrylate, and hydroxyethyl methacrylate are preferable.

The non-mordant monomer may be used alone or in combination of two or more thereof.

Other preferable examples of the cationic polymer include polydiallyldimethylammonium chloride, polymethacryloyloxyethyl-β-hydroxyethyldimethyl ammonium chloride, polyethyleneimine, polyallylamine and derivatives thereof, polyamide-polyamine resin, cationized starch, dicyandiamido formalin condensate, dimethyl-2-hydroxy propyl ammonium salt polymer, polyamidine, polyvinylamine, dicyan cationic resins such as dicyandiamido-formalin polycondensate, polyamine cationic resins such as dicyanamido-diethylenetriamine polycondensate, epichlorohydrin-dimethylamine addition polymer, dimethyl diallyl ammonium chloride-SO₂ copolymer, diallylamine salt-SO₂ copolymer, (meth)acrylate-containing polymers having a quaternary ammonium salt group substituted alkyl group in the ester moiety thereof, and styryl polymers having a quaternary ammonium salt group-substituted alkyl group.

Specific examples of the other cationic polymer include those described in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134, and 1-161236, U.S. Pat. Nos. 2,484,430, 2,548,564, 3,148,061, 3,309,690, 4,115,124, 4,124,386, 4,193,800, 4,273,853, 4,282,305, and 4,450,224, JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, 2001-301314, Japanese Patent Application Publication (JP-B) Nos. 5-35162, 5-35163, 5-35164, 5-88846, JP-A Nos. 7-118333 and 2000-344990, Japanese Patent Nos. 2648847 and 2661677.

Among them, diallyldimethylammonium chloride polymers, or (meth)acrylate-containing polymers having a quaternary ammonium salt group in the ester moiety thereof are preferable.

The cationic polymer preferably has a weight average molecular weight of 200,000 or less, and an I/O value of 3.0 or less, for preventing bleeding over time.

### (Water-Soluble Multivalent Metal Salt)

In the colloidal silica layer, the cationic compound preferably is a water-soluble multivalent metal salt.

Examples of the water-soluble multivalent metal salt include water-soluble salts of metals selected from calcium, barium, manganese, copper, cobalt, nickel, aluminum, iron, zinc, zirconium, chromium, magnesium, tungsten, and molybdenum.

Specific examples of the metal salt include calcium acetate, calcium chloride, calcium formate, calcium sulfate, barium acetate, barium sulfate, barium phosphate, manganese chloride, manganese acetate, manganese formate dihydrate, manganese sulfate ammonium hexahydrate, cupric chloride, copper (II) ammonium chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidesulfate tetrahydrate, aluminum sulfate, aluminum sulfite, aluminum thiosulfate, poly aluminum chloride, aluminum nitrate nonahydrate, aluminum chloride hexahydrate, ferrous bromide, ferrous chloride, ferric chloride, ferrous sulfate, ferric sulfate, zinc bromide, zinc chloride, zinc nitrate hexahydrate, zinc sulfate, zirconium acetate, zirconium chloride, zirconyl chloride octahydrate, zirconium hydroxychloride, chromium acetate, chromium sulfate, magnesium sulfate, magnesium chloride hexahydrate, magnesium citrate nonahydrate, sodium phosphotungstate, sodium tungsten citrate, undecatungstophosphoric acid n-hydrate, undecatungstosilicic acid 26-hydrate, molybdenum chloride, and undecamolybdophosphoric acid n-hydrate.

The water-soluble multivalent metal salt is preferably at least one selected from water-soluble aluminum compounds, zirconium compounds, and titanium compounds.

Known examples of the aluminum compound include inorganic salts such as aluminum chloride and hydrates thereof, aluminum sulfate and hydrates thereof, and ammonium alum. Other examples include basic poly aluminum hydroxide compounds, which are inorganic aluminum-containing cationic polymers. Among them, basic poly aluminum hydroxide compounds are preferable.

The basic poly aluminum hydroxide compound is a water-soluble poly aluminum hydroxide which stably contains basic and polymeric polynuclear condensed ions such as [Al₆(OH)₁₅]³⁺, [Al₈(OH)₂₀]⁴⁺, [Al₁₃(OH)₃₄]⁵⁺, or [Al₂₁(OH)₆₀]³⁺, and the main component of the compound is expressed by the following formula 1, 2, or 3.

[Al₂(OH)ₙCl₆₋ₙ]ₘ Formula 1

[Al(OH)₃]ₙAlCl₃ Formula 2

Alₙ(OH)ₘCl₍₃ₙ₋ₘ₎(0<m<3n) Formula 3

Examples of commercially available products thereof include poly aluminum chloride as a water treatment agent (trade name: PAC, manufactured by Taki Chemical Co., Ltd.) and poly aluminum hydroxide (trade name: Paho, manufactured by Asada Chemical Industry Co., Ltd., and PURACHEM WT (trade name, manufactured by Riken Green Co., Ltd.). Other products of various grades for similar purposes are also available from other manufacturers. According to the invention, these commercial products may be used as supplied. However, some products having an inappropriately low pH may be subjected to pH adjustment.

The zirconium compound is not particularly limited, and may be selected from various compounds. Examples of the zirconium compound include zirconyl acetate, zirconium chloride, zirconium oxychloride, zirconium hydroxychloride, zirconium nitrate, basic zirconium carbonate, zirconium hydroxide, zirconium carbonate ammonium, potassium zirconium carbonate, zirconium sulfate, and zirconium fluoride. Among them, zirconyl acetate is preferable.

The titanium compound is not particularly limited, and may be selected from various compounds. Examples of the titanium compound include titanium chloride and titanium sulfate.

These compounds may have an inappropriately low pH. In that case, they may be subjected to pH adjustment as appropriate. According to the invention, the term “water-soluble” means being soluble in water at a ratio of 1% by mass or more at a normal temperature and under a normal pressure.

According to the invention, in cases where water-soluble multivalent metal salts are used, it is particularly preferable that at least one of them be zirconyl acetate from the viewpoint of exerting bleeding inhibitory effect on a broad range of dyes. The content of zirconyl acetate in the ink receiving layer is preferably 0.3 g/m² or less, and more preferably 0.01 to 0.02 g/m².

In cases where zirconyl acetate is used, it is preferable that zirconyl acetate be added to a dispersion liquid of fine particles in advance and then mixed with a binder from the viewpoint of stabilizing the viscosity of the coating liquid, and it is more preferable that the fine particles be dispersed together with zirconyl acetate in a liquid.

According to the invention, the content of the water-soluble multivalent metal salt in the colloidal silica layer is preferably from 0.1 to 20% by mass, and more preferably from 1 to 10% by mass with respect to the colloidal silica.

The water-soluble multivalent metal salt may be used alone, but preferably in combination of two or more thereof.

The cationic compound may be used alone, or in combination of two or more thereof. The cationic polymer may be used in combination with other organic and/or inorganic mordant.

The content of the cationic compound is preferably from 0.5% to 10%, and more preferably from 2% to 5% with respect to the solid content of the colloidal silica from the viewpoint of dispersion stability of the colloidal silica particles.

### —Compound Having an Amine Oxide Group—

According to the invention, the colloidal silica layer contains at least one compound having an amine oxide group. The combination of the cationic compound with the compound having an amine oxide group in the colloidal silica layer prevents the aggregation of the colloidal silica layer coating liquid for forming the colloidal silica layer. As a result of this, the resultant ink jet recording medium has an improved surface glossiness, and achieves a higher image density when an image is recorded.

The compound having an amine oxide group is preferably alkylamine oxide having 10 to 24 carbon atoms. The long-chain alkyl group having 10 to 24 carbon atoms may sufficiently decrease the surface tension of the colloidal silica layer coating liquid and prevent aggregation of the colloidal silica.

It is more preferable that the compound having an amine oxide group have 12 to 18 carbon atoms.

Examples of the compound having an amine oxide group include: saturated long-chain alkylamine oxides such as dodecyldimethylamine oxide, myristyldimethylamine oxide, and stearyldimethylamine oxide; unsaturated long-chain alkylamine oxides such as oleyldimethylamine oxide; dihydroxyethyldodecylamine oxide; and those having another functional group such as polyoxyethylene coconut oil alkyldimethylamine oxide. The compound is not limited to the above examples as long as it has an amine oxide group. Among them, long-chain alkylamine oxides having 10 to 24 carbon atoms are preferable, and saturated alkylamine oxides having 12 to 18 carbon atoms are more preferable for sufficiently decreasing the surface tension of the colloidal silica layer coating liquid and preventing aggregation of the colloidal silica.

The content of the compound having an amine oxide group in the colloidal silica layer is preferably from 0.01 to 0.5 g/m², and more preferably, 0.02 to 0.3 g/m², for adjusting the surface tension of the colloidal silica-containing coating liquid and improving the glossiness (and preferably improving the image density).

Regarding the combination of the compound having an amine oxide group with the cationic compound, the combination of poly aluminum chloride with an alkylamine oxide having 10 to 24 carbon atoms is preferable, and the combination of poly aluminum chloride with an alkylamine oxide having 12 to 18 carbon atoms is more preferable, for improving the glossiness (and preferably improving the image density).

### —Other Additives—

According to the invention, the colloidal silica layer may contain other additives as necessary such as a water-soluble binder in addition to the colloidal silica, cationic compound, and compound having an amine oxide group.

### <Ink Receiving Layer>

The ink jet recording medium of the invention includes at least one ink receiving layer between a support and the colloidal silica layer, wherein the ink receiving layer may contain fine particles and a water-soluble resin. In particular, the layer preferably contains fine particles, a water-soluble resin, a crosslinking agent, a cationic resin, and a surfactant. The components of the ink receiving layer are further described below.

### (Water-Soluble Resin)

According to the invention, the ink receiving layer preferably contains a water-soluble resin (hydrophilic binder) thereby having a porous structure.

Examples of the water-soluble resin used in the invention include polyvinyl alcohol resins, which have hydroxy groups as hydrophilic structural units [for example, polyvinyl alcohol (PVA), acetoacetyl modified polyvinyl alcohol, cation modified polyvinyl alcohol, anion modified polyvinyl alcohol, silanol modified polyvinyl alcohol, and polyvinyl acetal], cellulose resins [for example, methyl cellulose (MC), ethyl cellulose (EC), hydroxyethyl cellulose (HEC), carboxymethyl cellulose (CMC), hydroxypropyl cellulose (HPC), hydroxyethylmethyl cellulose, and hydroxypropylmethyl cellulose], chitins, chitosans, starch, ether linkage containing resins [for example, polyethylene oxide (PEO), polypropylene oxide (PPO), polyethylene glycol (PEG), and polyvinyl ether (PVE)], and resins having carbamoyl groups [for example, polyacrylamide (PAAM), polyvinyl pyrrolidone (PVP), and polyacrylic acid hydrazide].

Other examples include polyacrylic acid salts, maleic acid resins, alginic acid salts, and gelatins having carboxyl groups as dissociative groups.

According to the invention, the ink receiving layer preferably contains at least one selected from polyvinyl alcohol resins, cellulose resins, ether linkage containing resins, resins having carbamoyl groups, resins having carboxy groups, and gelatins among the above water-soluble resins, from the viewpoint of ink absorbency.

According to the invention, among the above water-soluble resins, polyvinyl alcohol (PVA) is preferable.

The degree of saponification of the polyvinyl alcohol (PVA) used in the invention is preferably from 75 to 95 mol %, more preferably from 77 to 90 mol %, and particularly preferably from 80 to 90 mol % from the viewpoint of color formation density. The degree of polymerization of polyvinyl alcohol (PVA) is preferably from 1,400 to 5,000, and more preferably from 2,300 to 4,000 for achieving sufficient film strength. A polyvinyl alcohol having a degree of polymerization of less than 1400 and a polyvinyl alcohol having a degree of polymerization of 1400 or more may be used together.

The content of the water-soluble resin in the ink receiving layer is preferably from 5 to 40% by mass, and more preferably from 10 to 30% by mass with respect to the total solid content in the ink receiving layer for preventing decrease of the film strength and cracking during drying caused by the insufficiency of the resin content, and for preventing blockage of pores with the excess resin to decrease the porosity and ink absorbency.

The below-described fine particles and the water-soluble resin which are main components of the ink receiving layer may be each a single material, or a mixture of plural materials.

Examples of the polyvinyl alcohol include unmodified polyvinyl alcohol (PVA), cation modified PVA, anion modified PVA, silanol modified PVA, and other polyvinyl alcohol derivatives. The polyvinyl alcohol may be used alone or in combination of two or more kinds thereof.

The PVA has hydroxy groups in the structural units thereof. The hydroxy groups and silanol groups on the surfaces of silica fine particles form hydrogen bonds to promote the formation of three-dimensional network structure composed of chain units of secondary particles of the silica fine particles. The formation of the three-dimensional network structure is considered to provide an ink receiving layer having a highly porous structure having high porosity.

In the ink jet recording medium obtained according to the invention, the porous ink receiving layer obtained as described above rapidly absorbs ink by capillary phenomenon to form favorable circular dots without ink bleeding.

### (Fine Particles)

According to the invention, the ink receiving layer preferably contains fine particles.

Examples of the fine particles in the invention include at least one kind of fine particles selected from organic fine particles, silica fine particles, alumina fine particles, and pseudo-boehmite aluminum hydroxide fine particles. Among them, silica fine particle, alumina fine particle, and pseudo-boehmite aluminum hydroxide fine particles are preferable.

According to the invention, the average primary particle diameter of the fine particles is preferably 50 nm or less, more preferably 30 nm or less, and particularly preferably 15 nm or less. Fine particles having an average primary particle diameter of 50 nm or less effectively improves ink absorbency, and improves the surface glossiness of the ink receiving layer. The average primary particle diameter of the fine particles is not particularly limited as to its lower limit, but preferably 1 nm or more.

Among the fine particles, fumed silica and fumed alumina produced by a gas phase process have markedly large specific surface areas, so that efficiently absorb and retain ink. In addition, they have low refractive indexes, and thus, when dispersed to have appropriately fine particle diameter, it is possible to impart transparency to the ink receiving layer and achieve high color densities and favorable color formation properties. The transparency of the ink receiving layer is important for OHP or other applications requiring transparency, as well as photographic glossy paper and other recording sheets for obtaining high color densities and favorable color formation properties and glossiness.

In particular, silica fine particles have silanol groups on their surfaces, and readily adhere to each other through hydrogen bonds of the silanol groups. In addition, the fine particles adhere to each other via the silanol groups and water-soluble resin. As a result, when the average primary particle diameter is 15 nm or less, the porosity of the ink receiving layer is increased, whereby a highly transparent structure is formed, and ink absorbency is effectively improved.

General silica fine particles are broadly classified into wet process (precipitation process) particles and dry process (gas phase process) particles depending on the manufacturing method. In the wet process, usually, hydrous silica is produced by generating activated silica by acid decomposition of silicate, and then appropriately polymerizing, aggregating and precipitating the activated silica. On the other hand, in the gas phase process, usually, anhydrous silica is produced by hydrolysis of silicon halide in a high-temperature gas phase (flame hydrolysis process), or by heating, reducing and vaporizing silica sand and cokes by arcing in an electric furnace, followed by oxidation with air (arc process). The above-described “fumed silica” refers to fine particles of anhydrous silica produced by a gas phase process.

Fumed silica is different from hydrous silica in, for example, the density of the silanol groups on the surface, and the presence or absence of pores, so that they exhibit different properties. Fumed silica is suitable to form a three-dimensional structure having a high porosity. The reason is not evident, but is considered as follows: hydrous silica tends to aggregate because it has as much as 5 to 8 silanol groups per square nanometer of the particle surfaces, while fumed silica tends to flocculate because it has 2 to 3 silanol groups per square nanometer of the particle surfaces, which results in a structure having a high porosity.

According to the invention, the fine particles are preferably amorphous silica or alumina particles formed by a precipitation or gas phase process. In particular, fumed silica or fumed alumina having an average primary particle diameter of 30 nm or less is preferable. Striking effect is achieved when the fumed silica or fumed alumina is used at a ratio of 50% by mass or more, preferably 70% by mass or more, and more preferably 90% by mass or more with respect to the total fine particles. In cases where fumed silica is used, the density of silanol groups on the surfaces of the silica fine particles is preferably from 2 to 3 per square nanometer.

According to the invention, fumed alumina provides a higher color formation density and a higher glossiness than fumed silica. The reason for this is considered that fumed alumina has a higher refractive index and more strongly reflects light on its surface than fumed silica. In addition, fumed alumina particles are more spherical than alumina hydrate such as pseudo-boehmite, and thus provide good ink absorbency. Therefore, the use of fumed alumina in the invention further improves ink absorbency. In addition, although the reason is unknown, fumed alumina is less likely to cause minute cracks in the ink receiving layer than fumed silica. Such minute cracks are caused by various factors during production. The use of fumed alumina allows striking reduction of minute cracks caused by, for example, shrinkage of the coating film during drying.

A coating film containing fumed alumina tends to be stronger than that containing fumed silica, so that defects such as scratches are less likely to be caused. A pigment dispersion liquid containing fumed alumina may have a higher solid content than that containing fumed silica. Therefore, the solid content of the final coating liquid containing fumed alumina may be increased thereby reducing the drying load and providing high productivity. When preparing an aqueous dispersion liquid of fumed alumina, the solid content in the dispersion liquid may be further increased by the addition of a small amount of acidic component. The acidic component is particularly preferably boric acid, and a small amount of which is added during dispersion of the pigment.

In order to increase the pigment dispersion concentration, it is preferable that a known dispersant be used. Preferable examples of the dispersant include cationic polymers having a secondary or tertiary amino group, or a quaternary ammonium salt group, nonionic or cationic surfactants, and low molecular weight polyvinyl alcohols.

When fumed alumina is used as the fine particles, the amount is preferably from 4 to 12 parts by mass, more preferably from 5 to 10 parts by mass, and particularly preferably from 6 to 9 parts by mass with respect to 1 part by mass of the water-soluble binder. When fumed alumina is used, the amount of the binder necessary for achieving a sufficient film strength is smaller than the case where fumed silica is used.

In cases where the ink receiving layer has a multilayer structure, the outermost layer preferably contains fumed alumina for developing the characteristics of fumed alumina.

According to the invention, the fine particles may be used alone, or in combination of two or more kinds thereof. In cases where two or more kinds of fine particles are used together, any combination of precipitated silica, fumed silica, and fumed alumina is preferable.

According to the invention, in cases where the fine particles are organic fine particles, the particles should be particulate in the ink receiving layer. Examples of the organic fine particles include polymer fine particles obtained by, for example, emulsion polymerization, microemulsion polymerization, soap free polymerization, seed polymerization, dispersion polymerization, or suspension polymerization, and specific examples thereof include powders of polyethylene, polypropylene, polystyrene, polyacrylate, polyamide, a silicon resin, a phenolic resin, and a natural polymer, and polymer fine particles in the form of latex or emulsion. The organic fine particles preferably have cationized surfaces. The Tg of the organic fine particles is not particularly limited, but preferably 40° C. or higher, and more preferably 80° C. or higher when they are used alone.

In cases where the fine particles are colloidal silica, preferable colloidal silica is that described in the explanation of the colloidal silica layer. However, colloidal silica has so poor void formation ability that it is unlikely to form a highly porous ink receiving layer having high porosity. In such a case, a high void formation effect is achieved by, for example, using a combination of precipitated silica or fumed silica with colloidal silica in the layer, or forming multiple layers containing colloidal silica.

In cases where fumed silica is used, the primary particle diameter is almost correlated with the specific surface area measured by the BET method. The BET specific surface area of the fumed silica is preferably from 100 m²/g to 400 m²/g, and particularly preferably from 300 to 350 m²/g for satisfying stability of the coating liquid, the ink absorbency and the glossiness of the image-receiving paper.

### —Content Ratio of Fine Particles to Water-Soluble Resin—

According to the invention, the content ratio of the fine particles (preferably silica fine particles; x) to the water-soluble resin (y) in the ink receiving layer [PB ratio (x/y), the mass of the fine particles to 1 part by mass of the water-soluble resin] markedly influences the layer structure of the ink receiving layer. More specifically, the larger the PB ratio, the larger the porosity, pore volume, and surface area (per unit mass) become. The PB ratio (x/y) is preferably from 1.5/1 to 10/1 for preventing the decrease of the film strength and cracking during drying due to an excessive PB ratio, and for preventing blockage of pores with the resin due to a too small PB ratio, which results in the decrease of the porosity to decrease ink absorbency.

The recording medium may be subjected to stress during passing through the transfer system in the ink jet printer. Therefore, the ink receiving layer should have a sufficient film strength. In cases where the recording medium is cut into sheets, the ink receiving layer should have a sufficient film strength for preventing cracking and exfoliation of the ink receiving layer. From such viewpoints, the PB ratio (x/y) is preferably 6/1 or less, and, for achieving high speed ink absorbency with an ink jet printer, preferably 3/1 or more.

For example, in order to form a three-dimensional network structure composed of chain units of secondary particles of silica fine particles, for example, anhydrous silica fine particles having an average primary particle diameter of 20 nm or less and a water-soluble resin are completely dispersed in an aqueous solution at a PB ratio (x/y) of 3/1 to 6/1 to make a coating liquid, and the coating liquid is applied to a support, and the coating layer is dried. Thus a translucent porous layer having an average pore diameter of 30 nm or less, a porosity of 50% to 80%, a specific pore volume of 0.5 ml/g or more, and a specific surface area of 100 m²/g or more is readily formed.

### (Surfactant)

According to the invention, the ink receiving layer may contain various known surfactants.

In order to improve the viscosity stability of the ink receiving layer coating liquid thereby forming a favorable coated surface, polyoxyalkylene decyl ether or polyoxyalkylene tridecyl ether may be used as a surfactant (hereinafter referred to as a “POE surfactant”). The decyl group or tridecyl group in the POE surfactant is preferably branched. In addition, in order to increase the stability of the coating liquid and prevent bleeding caused by heat and humidity, the POE surfactant is particularly preferably nonionic.

In order to prevent aggregation of colloidal silica, it is preferable that the compound having an amine oxide group used in the colloidal silica layer be used as the surfactant. The details and preferable range of the compound having an amine oxide group are the same as those of the compound having an amine oxide group contained in the colloidal silica layer.

The POE surfactant preferably satisfies the following condition (1) or (2):

(1) when the water solubility is 1% by mass or more, a 1% by mass aqueous solution has a cloud point of 30° C. or higher, and a HLB value of 10.5 or more; or

(2) when the water solubility is less than 1% by mass, a 10% by mass solution in a mixed solvent composed of water and diethylene glycol monobutyl ether at a ratio of 75 to 25 has a cloud point of 30° C. or higher but 80° C. or lower, and a HLB value of 10.5 or more but less than 15.

In this regard, a water solubility of 1% by mass or more means being soluble in water. On the other hand, a water solubility of less than 1% by mass means being insoluble in water.

The solubility of the POE surfactant in water, that is, whether the surfactant is soluble in water or not is determined as follows: 1 g of the POE surfactant is added in 99 g of ion exchanged water, and the solution after stirring at 23° C. for 30 minutes is visually observed; and when the solution is transparent, the surfactant is evaluated as water-soluble.

(1) When the POE surfactant has a water solubility of 1% by mass or more (that is, the surfactant is water-soluble), the cloud point should be 30° C. or higher, and is preferably 40° C. or higher, and particularly preferably from 40 to 70° C. If the cloud point is lower than 30° C., the coating liquid is too viscous to form a favorable coated surface. The HLB value should be 10.5 or more, and is preferably from 12 to 16, and particularly preferably from 13 to 14. If the HLB value is less than 10.5, a favorable coated surface may not be obtained due to repelling.

(2) When the POE surfactant has a water solubility of less than 1% by mass (that is, the surfactant is insoluble in water), the cloud point should be 30° C. or higher but 80° C. or lower, and is preferably from 60 to 80° C., and particularly preferably from 70 to 80° C. If the cloud point is lower than 30° C., repelling tends to occur during application and drying, so that a favorable coated surface may not be formed. On the other hand, if the cloud point is higher than 80° C., the coating liquid may not have a sufficient viscosity stability, and streaks tend to occur.

The HLB value should be 10.5 or more but less than 15, and is preferably from 11 to 14, and particularly preferably from 12 to 13. If the HLB value is less than 10.5, a favorable coated surface may not be obtained due to repelling. On the other hand, if the HLB value is 15 or more, the coating liquid has a high viscosity and develops streaks during application.

### —Measurement of Cloud Point—

The POE surfactant has two functional groups within one molecule thereof; a hydrophilic group having a high affinity with water, and a hydrophobic group antagonistic to the hydrophilic group. Dissolution of the nonionic surfactant in water is caused by hydration of the ether oxygen atom in the ethylene oxide chain with water molecules. The hydration power by hydrogen bonds decreases with the increase of the temperature, and the solubility rapidly decreases and the surfactant starts to deposit when the temperature reaches a specific point. As a result of this, white turbidity develops. The specific temperature at which the white turbidity develops is called a cloud point.

According to the invention, the cloud point is measured by visually observing a surfactant solution and determining the temperature at which white turbidity develops. The measurement is conducted on a solution of the POE surfactant, and thus the solvent is changed according to the water solubility. Specifically, one having a water solubility of 1% by mass or more (water-soluble one) is measured in a state of 1% by mass aqueous solution, and one having a water solubility of less than 1% by mass (water-insoluble one) is measured in a state of a 10% by mass solution of the POE surfactant in a mixed solvent composed of diethylene glycol monobutyl ether and water at a ratio of 25 to 75.

Specific examples of the water-soluble POE surfactant include NOIGEN XL-100, NOIGEN SD-60, NOIGEN SD-70, NOIGEN SD-110, NOIGEN XL-100, EMULGEN 109P, and NOIGEN ET106A. Examples of the water-insoluble surfactant include NOIGEN TDS-70, NOIGEN SD-30, NOIGEN XL-60, and NOIGEN SD-30.

### —Calculation of HLB Value—

The HLB value is calculated as follows: a virtual most hydrophilic compound having an infinitely long hydrophilic group bonded to the lipophilic group of a POE surfactant is assumed to have an HLB value of 20, and a lipophilic compound having no hydrophilic group is assumed to have an HLB value of 0, and the relative value with respect to those values is determined as the HLB value for each POE surfactant. The HLB value is usually calculated by the Griffin's formula:

HLB value=20×Mw/M

wherein M is the molecular weight of the nonionic surfactant, and Mw is the molecular weight of the hydrophilic moiety.

The alkylene groups in the POE surfactant (polyoxyalkylene decyl ether or polyoxyalkylene tridecyl ether) are particularly preferably ethylene groups.

According to the invention, specific examples of the preferable POE surfactant include polyoxyethylene isodecyl ether and polyoxyethylene tridecyl ether. Of these, polyoxyethylene isodecyl ether is more preferable.

According to the invention, the content of the surfactant (solid content) in the ink receiving layer is preferably from 0.005 to 0.3% by mass, and more preferably from 0.01 to 0.1% by mass with respect to the mass of the ink receiving layer coating liquid for preventing coating defects such as daubing, steaks and blocks during application of the ink receiving layer.

In cases where a compound having an amine oxide group is used as the surfactant, the content (solid content) in the ink receiving layer is preferably from 0.005 to 0.2% by mass, and more preferably from 0.02 to 0.1% by mass with respect to the mass of the ink receiving layer coating liquid for preventing coating defects such as daubing, steaks and blocks, and aggregation of colloidal silica during application of the ink receiving layer.

In cases where the surfactant is polyoxyalkylene decyl ether or polyoxyalkylene tridecyl ether, the content (solid content) is preferably from 1 to 50% by mass, and more preferably from 2 to 30% by mass with respect to the fine particles for achieving an intended low viscosity.

### (Other Components)

According to the invention, the ink receiving layer may contain, in addition to the above components, other components such as a latex, a cationic substance, a water-soluble multivalent metal salt, and a crosslinking agent.

### —Latex—

According to the invention, polyoxyalkylene decyl ether or polyoxyalkylene tridecyl ether useful as the surfactant in the ink receiving layer may decrease the strength of the coating, or deteriorate bleeding caused by heat and humidity after printing. These surfactants are preferably combined with a latex. The combination with a latex further reduces the occurrence of bleeding.

The particle diameter of the latex in water is preferably 1 μm or less, and more preferably from 1 to 100 nm.

Preferable examples of the latex include polystyrene latexes, styrene-butadiene copolymer latexes, acrylonitrile-butadiene latexes, acrylic acid latexes, styrene-acrylic latexes, urethane latexes, methacrylic acid latexes, vinyl chloride latexes, vinyl acetate latexes, and ethylene-vinyl acetate latexes. Among them, styrene, acrylic acid, methacrylic acid, and urethane latexes are preferable, and urethane latexes and aqueous dispersions thereof are particularly preferable. These latexes and aqueous dispersions thereof may be those synthesized by a known polymerization process described in, for example, “Latest Applied Technology of Latex Emulsion”, (Motoharu Okikura, Chunichisha Co., Ltd., 1991, p. 88 to 90).

The latex is preferably a polyurethane latex which is synthesized through soap free polymerization and has a dispersion particle diameter of 1 μm or less, preferably 100 nm or less, and is most preferably cation modified.

The Tg of the latex is not particularly limited, but is preferably 40° C. or higher for improving the strength of the coating, while preferably 40° C. or lower for improving brittleness. After application and drying, the cationized polyurethane dispersion is preferably in the form of a film and not of particles. The film form decreases the haze of the image-receiving layer to provide higher color formation densities.

According to the invention, in order to achieve a favorable glossiness suitable for photographic applications, the latex resin is particularly preferably a colloidal dispersion containing a cationic urethane resin having a volume average particle diameter of 30 nm or less, and a glass transition temperature of the cationic urethane resin of lower than 50° C.

Such a colloidal dispersion of a latex resin tends to promote the thickening of the coating liquid by the surfactant. In this case, the effect of the polyoxyalkylene decyl ether or polyoxyalkylene tridecyl ether surfactant is markedly achieved.

### —Cationic Substance—

According to the invention, the ink receiving layer preferably contains a cationic substance. The cationic substance is preferably the above-described cation modified latex, and may be other cationic polymer. The other cationic polymer is preferably the cationic polymer (cationic substance) described in the explanation of the colloidal silica layer.

In order to prevent bleeding over time, the other cationic polymer is preferably a cationic polymer having a weight average molecular weight of 200,000 or less, and an I/O value of 3.0 or less.

The other cationic polymers may be used alone, or in combination of two or more thereof. The other cationic polymer may be combined with other organic mordant and/or inorganic mordant.

According to the invention, the content of the other cationic polymer in the ink receiving layer is preferably from 1 to 30% by mass, more preferably from 2 to 15% by mass, and even more preferably from 3 to 10% by mass with respect to the mass of the total solid content in the ink receiving layer.

### —Water-Soluble Multivalent Metal Salt—

The ink jet recording medium of the invention preferably contains a water-soluble multivalent metal salt in the ink receiving layer thereby improving water resistance and bleeding resistance of the formed image. The water-soluble multivalent metal salt is preferably the water-soluble multivalent metal salt described in the explanation of the colloidal silica layer.

According to the invention, the content of the water-soluble multivalent metal salt in the ink receiving layer is preferably 0.1 to 20% by mass, and more preferably 1 to 10% by mass with respect to the fine particles.

The water-soluble multivalent metal salt may be used alone, but preferably is used in combination of two or more thereof.

### —Crosslinking Agent—

According to the invention, the ink receiving layer preferably contains a crosslinking agent for crosslinking the water-soluble resin, and particularly preferably has a porous structure composed of the fine particles and water-soluble resin crosslinked by the crosslinking agent.

The crosslinking agent may be selected from those suitable for the water-soluble resin contained in the ink receiving layer. In particular, boron compounds are preferable from the viewpoint of rapid crosslinking reaction. Examples of boron compound include borax, boric acid, borates such as orthoborates, InBO₃, ScBO₃, YBO₃, LaBO₃, Mg₃(BO₃)₂, and Co₃(BO₃)₂, diborates such as Mg₂B₂O₅ and Co₂B₂O₅, metaborates such as LiBO₂, Ca(BO₂)₂, NaBO₂, and KBO₂, tetraborates such as Na₂B₄O₇.10H₂O), pentaborates such as KB₅O₈.4H₂O, Ca₂B₆O₁₁.7H₂O, and CsB₅O₅. Among them, from the viewpoint of rapid crosslinking reaction, borax, boric acid, and borates are preferable, and boric acid is particularly preferable. It is most preferable that boric acid be combined with polyvinyl alcohol as a water-soluble resin.

According to the invention, the content of the crosslinking agent is preferably from 0.05 to 0.50 parts by mass, and more preferably from 0.08 to 0.30 parts by mass with respect to 1.0 part by mass of the water-soluble resin. When the content of the crosslinking agent is within the above range, the water-soluble resin is effectively crosslinked to prevent cracking and other problems.

In cases where gelatin is used as the water-soluble resin, the following crosslinking agent may be used other than a boron compound. Examples of the crosslinking agent include: aldehyde compounds such as formaldehyde, glyoxal, and glutaraldehyde; ketone compounds such as diacetyl and cyclopentanedione; active halogen compounds such as bis(2-chloroethylurea)-2-hydroxy-4,6-dichloro-1,3,5-triazine and 2,4-dichloro-6-S-triazine-sodium salt; active vinyl compounds such as divinylsulfonic acid, 1,3-vinylsulfonyl-2-propanol, N,N′-ethylenebis(vinylsulfonyl acetamide), and 1,3,5-triacryloyl-hexahydro-S-triazine; N-methylol compounds such as dimethylol urea and methylol dimethylhydantoin; melamine resins such as methylol melamine and alkylated methylol melamine; epoxy resins;

isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; epoxy compounds such as glycerol triglycidyl ether; ethyleneimino compounds such as 1,6-hexamethylene-N,N′-bisethylene urea; halogenated carboxy aldehyde compounds such as mucochloric acid and mucophenoxychloric acid; dioxane compounds such as 2,3-dihydroxydioxane; metal-containing compounds such as titanium lactate, aluminum sulfate, chrome alum, potassium alum, zirconyl acetate and chromium acetate; polyamine compounds such as tetraethylenepentamine; hydrazide compounds such as adipoyl dihydrazide; and low molecule compounds or polymers containing two or more oxazollin groups. These cross-linking agents may be used alone or in combination of two or more thereof.

According to the invention, the crosslinking agent may be added in the ink receiving layer coating liquid and/or the coating liquid for forming the layer adjacent to the ink receiving layer in the formation of the ink receiving layer. Alternatively, the ink receiving layer coating liquid may be applied to a support which has been coated with a coating liquid containing a crosslinking agent, or a crosslinking agent solution may be applied after applying and drying an ink receiving layer coating liquid containing no crosslinking agent, thereby supplying the crosslinking agent to the ink receiving layer. From the viewpoint of production efficiency, it is preferable that the crosslinking agent be added to the ink receiving layer coating liquid or the coating liquid for forming the layer adjacent to the ink receiving layer, whereby the crosslinking agent is supplied concomitantly with the formation of the ink receiving layer. In particular, in order to improve the printing density and glossiness of the image, the crosslinking agent is preferably contained in the ink receiving layer coating liquid. The concentration of the crosslinking agent in the ink receiving layer coating liquid is preferably from 0.05 to 10% by mass, and more preferably from 0.1 to 7% by mass.

### —Other Components—

According to the invention, the ink receiving layer contains the following components as necessary.

More specifically, the ink receiving layer may contain any ultraviolet absorber, antioxidant, and antifading agent such as singlet oxygen quencher for preventing degradation of the ink coloring materials.

Examples of the ultraviolet absorber include cinnamic acid derivatives, benzophenone derivatives, and benzotriazolylphenol derivatives. Specific examples thereof include butyl α-cyano-phenylcinnamate, o-benzotriazole phenol, o-benzotriazole-p-chlorophenol, o-benzotriazole-2,4-di-t-butylphenol, and o-benzotriazole-2,4-di-t-octylphenol. Other examples of the ultraviolet absorber include hindered phenol compounds, and preferable examples thereof include phenol derivatives substituted at the 2 and/or 6 position with a branched alkyl group.

Other examples include benzotriazole ultraviolet absorbers, salicylic acid ultraviolet absorbers, cyano acrylate ultraviolet absorbers, and oxalic acid anilide ultraviolet absorbers. They are described in, for example, JP-A Nos. 47-10537, 58-111942, 58-212844, 59-19945, 59-46646, 59-109055, 63-53544, JP-B Nos. 36-10466, 42-26187, 48-30492, 48-31255, 48-41572, 48-54965, and 50-10726, U.S. Pat. Nos. 2,719,086, 3,707,375, 3,754,919, and 4,220,711.

As the ultraviolet absorber, an optical brightener may be used such as a coumarin optical brightener. Specific examples thereof are described in, for example, JP-B Nos. 45-4699 and 54-5324.

Examples of the antioxidant include those described in European Patent Publication Nos. 223739, 309401, 309402, 310551, 310552, and 459416, German Patent Publication No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, and 63-113536;

JP-A Nos. 63-163351, 63-203372, 63-224989, 63-251282, 63-267594, and 63-182484, JP-A Nos. 1-239282, 2-262654, 2-71262, 3-121449, 4-291685, 4-291684, 5-61166, 5-119449, 5-188687, 5-188686, 5-110490, 5-1108437, and 5-170361, JP-B Nos. 48-43295 and 48-33212, and U.S. Pat. Nos. 4,814,262 and 4,980,275.

Specific examples thereof include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl)propane, 1,1-bis(4-hydroxyphenyl)-2-ethylhexane, 2-methyl-4-methoxy-diphenylamine, and 1-methyl-2-phenylindole.

These antifading agents may be used alone or in combination of two or more thereof. The antifading agent may be solubilized in water, dispersed, emulsified, or contained in microcapsules. The content of the antifading agent is preferably from 0.01 to 10% by mass with respect to the ink receiving layer coating liquid.

According to the invention, the ink receiving layer may contain a high-boiling point organic solvent for preventing curling. The high-boiling point organic solvent is preferably soluble in water. Examples of the water-soluble high-boiling point organic solvent include alcohols such as ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine, and polyethylene glycol having a weight average molecular weight of 400 or less. Among them, diethylene glycol monobutyl ether (DEGMBE) is preferable.

The content of the high boiling point organic solvent in the ink receiving layer coating liquid is preferably from 0.05 to 1% by mass, and particularly preferably from 0.1 to 0.6% by mass.

Further, in order to improve dispersibility of the inorganic pigment fine particles, various inorganic salts, and an acid or alkali as a pH controlling agent may be contained.

Further, metal oxide fine particles having electrical conductivity may be contained in order to prevent frictional electrification or peeling electrification on the surface, and various matting agents may be contained in order to reduce friction properties on the surface.

### <Support>

The support used in the invention may be a transparent support composed of a transparent material such as plastic, or an opaque support composed of an opaque material such as paper. In order to utilize the transparency of the ink receiving layer, it is preferable that a transparent support or an opaque support having a high glossiness be used. The support may be a read-only optical disk such as a CD-ROM or DVD-ROM, a recordable optical disk such as a CD-R or DVD-R, or a re-writable optical disk, on which the ink receiving layer is formed on the label surface side.

The material usable for the transparent support is preferably transparent and resistant to radiation heat given by an OHP or backlight display. Examples of the material include polyesters such as polyethylene terephthalate (PET), polysulfone, polyphenylene oxide, polyimide, polycarbonate, and polyamide. Among them, polyesters are preferable, and polyethylene terephthalate is particularly preferable.

The thickness of the transparent support is not particularly limited, but is preferably from 50 to 200 μm from the viewpoint of easiness of handling.

The high-glossiness opaque support preferably has a glossiness of 40% or more on the surface on which the ink receiving layer is provided. The glossiness is measured according to the method described in JIS P-8142 (Testing Method for 75° Specular Glossiness of Paper and Paperboard). Specific examples of the support are listed below.

High-glossiness paper supports such as art paper, coated paper, cast coated paper, and barayta coated paper used as a support of silver halide photographic prints; high-glossiness opaque films, which may be calendered, composed of a white pigment or the like and a plastic film of a polyester (for example, polyethylene terephthalate (PET)), a cellulose ester (for example, nitrocellulose, cellulose acetate, or cellulose acetate butylate), polysulfone, polyphenylene oxide, polyimide, polycarbonate, or polyamide; and composite supports composed of the various paper supports, transparent support, or high-glossiness film containing a white pigment or the like having on their surface a polyolefin coating layer containing a white pigment or no white pigment.

Other preferable examples include a foamed polyester film containing a white pigment (for example, foamed PET containing polyolefin fine particles and pores formed by stretching), and resin coated paper used as photographic paper for silver halide photographic prints.

The thickness of the opaque support is not particularly limited, but preferably from 50 to 300 μm from the viewpoint of ease of handling.

In order to improve wetting properties and adhesion properties, the support is preferably subjected to surface treatment such as corona discharge treatment, glow discharge treatment, flame treatment, or ultraviolet radiation treatment.

The base paper used for the paper support such as resin coated paper is described below.

The base paper is composed mainly of wood pulp, and as necessary contain synthetic pulp such as polypropylene, or synthetic fibers such as nylon or polyester. The wood pulp may be LBKP, LBSP, NBKP, NBSP, LDP, NDP, LUKP, or NUKP, and is preferably composed mainly of LBKP, NBSP, LBSP, NDP, and LDP, which contain much short fiber. The proportion of LBSP and/or LDP is preferably from 10% to 70% by mass.

The pulp is preferably chemical pulp (for example, sulfate pulp or sulfite pulp) containing less impurity, and may be subjected to bleaching treatment to improve whiteness.

As appropriate, the base paper may contain a sizing agent such as a higher fatty acid or alkyl ketene dimer, a white pigment such as calcium carbonate, talc, or titanium oxide, a paper strengthening agent such as starch, polyacrylamide, or polyvinyl alcohol, an optical brightener, a moisture retention agent such as polyethylene glycol, a dispersant, and a softening agent such as quaternary ammonium.

The freeness of the pulp used for papermaking is preferably from 200 to 500 ml in terms of CSF. Regarding the fiber length after beating, the total of the 24 mesh residue and 42 mesh residue as defined in JIS P-8207 is preferably from 30 to 70% by mass. The 4-mesh residue is preferably 20% by mass or less.

The basis weight of the base paper is preferably from 30 to 250 g, and particularly preferably from 50 to 200 g. The thickness of the base paper is preferably from 40 to 250 μm. The base paper may be calendered during or after papermaking for achieving high smoothness. The density of the base paper is usually from 0.7 to 1.2 g/m² (JIS P-8118). The stiffness of the base paper is preferably from 20 to 200 g under the conditions defined in JIS P-8143.

The surface of the base paper may be coated with a surface sizing agent. The surface sizing agent may be the same sizing agent as that contained in the base paper.

The pH of the base paper is preferably from 5 to 9 when measured by the hot water extraction defined in JIS P-8113.

The polyethylene for coating the front and back sides of the base paper is usually low density polyethylene (LDPE) and/or high density polyethylene (HDPE), and may contain, for example, other LLDPE or polypropylene. It is preferable that a hydrotalcite compound be used for deactivating the catalyst for the high density polyethylene. The content of the compound in the high density polyethylene is preferably from 100 to 2,000 ppm, and more preferably from 200 to 1,000 ppm with respect to the high density polyethylene. The antioxidant is preferably a secondary antioxidant (particularly phosphorus antioxidant) alone, and the content of the antioxidant in the high density polyethylene is preferably 100 ppm or more but 2,000 ppm or less, and more preferably 200 ppm or more but 1,000 ppm or less with respect to the high density polyethylene (HDPE).

In particular, the polyethylene layer on the side having the ink receiving layer preferably contains, like many other photographic paper, rutile or anatase type titanium oxide, an optical brightener, and ultramarine blue thereby improving the opacity, whiteness and hue. The content of titanium oxide is preferably from about 3 to 40% by mass, and more preferably from 4 to 30% by mass with respect to polyethylene. The thickness of the polyethylene layer is not particularly limited, but is preferably from 10 to 50 μm for the front and back side layers. In order to impart adhesiveness with the ink receiving layer, an undercoat layer may be provided on the polyethylene layer. The undercoat layer preferably contains aqueous polyester, gelatin, or PVA. The thickness of the undercoat layer is preferably from 0.01 to 5 μm.

The polyethylene coated paper may be used as glossy paper, or may be subjected to so-called embossing treatment during application of polyethylene by melt-extrusion on the surface of the base paper thereby giving a matte or tweed finish like an ordinal photographic paper.

The support may have a back coat layer. Examples of components of the back coat layer include a white pigment, an aqueous binder, and other components.

Examples of the white pigment contained in the back coat layer include inorganic white pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrolyzed halloysite, magnesium carbonate, and magnesium hydroxide, and organic pigments such as styrenic plastic pigments, acrylic plastic pigments, polyethylene, microcapsules, urea resins, and melamine resins.

Examples of the aqueous binder used in the back coat layer include water-soluble polymers such as a styrene/maleate copolymer, a styrene/acrylate copolymer, polyvinyl alcohol, silanol modified polyvinyl alcohol, starch, cationized starch, casein, gelatin, carboxymethyl cellulose, hydroxyethyl cellulose, and polyvinyl pyrrolidone, and water-dispersible polymers such as a styrene butadiene latex and an acryl emulsion.

Examples of the other components contained in the back coat layer include an anti-foaming agent, a foam inhibitor, a dye, an optical brightener, a preservative, and a waterproofing agent.

### <Production Method for Ink Jet Recording Medium>

The ink jet recording medium of the invention may be produced by applying an ink receiving layer coating liquid A containing the components of the ink receiving layer, and a colloidal silica layer coating liquid B containing the components of the colloidal silica layer to a support, and drying the coatings.

The production of the ink jet recording medium of the invention may include addition of a basic solution containing a boron compound to the ink receiving layer and the colloidal silica layer, for example: (1) at the same time of formation of the ink receiving layer and the colloidal silica layer by simultaneous application of the ink receiving layer coating liquid A and the colloidal silica layer coating liquid B, or (2) during drying of the ink receiving layer and the colloidal silica layer formed by application of the ink receiving layer coating liquid A and the colloidal silica layer coating liquid B and before the ink receiving layer and the colloidal silica layer exhibit decreasing rate drying.

The coating liquids may be applied using, for example, a slide bead coater.

According to the invention, a high glossiness ink jet recording medium is provided even when a colloidal silica layer as the outermost layer is formed on the ink receiving layer on a support.

Exemplary embodiments of the present invention are as follows.
<1> An ink jet recording medium comprising, on a support, at least one ink receiving layer and a colloidal silica layer containing a cationic compound and a compound having an amine oxide group in this order.
<2> The ink jet recording medium of <1>, wherein the compound having an amine oxide group is an alkylamine oxide having 10 to 24 carbon atoms.
<3> The ink jet recording medium of <1>, wherein the cationic compound is a multivalent metal salt.
<4> The ink jet recording medium of <3>, wherein the multivalent metal salt is selected from the group consisting of aluminum compounds, zirconium compounds, and titanium compounds.
<5> The ink jet recording medium of <3>, wherein the multivalent metal salt is poly aluminum chloride.
<6> The ink jet recording medium of <1>, wherein the cationic compound is a cationic polymer.
<7> The ink jet recording medium of <1>, wherein the ink receiving layer comprises particles and a water-soluble resin.

### EXAMPLES

The present invention is further described below by the following examples, but the invention is not limited to these examples without departing from the scope of the invention. Unless otherwise noted, “part” means part by mass.

### Example 1

### <Making of Support>

50 parts of acacia LBKP and 50 parts of aspen LBKP were respectively beaten with a disc refiner to have a Canadian freeness of 300 ml to make a pulp slurry.

Subsequently, to the obtained pulp slurry, 1.3% of cationic starch (trade name: CATO 304L, manufactured by Japan NSC), 0.15% of anionic polyacrylamide (trade name: POLYACRON ST-13, manufactured by Seiko Chemical Co.), 0.29% of an alkylketene dimmer (trade name: SIZEPINE K, manufactured by Arakawa Kagaku Industries, Ltd.), 0.29% of epoxidized behenic acid amide, and 0.32% of polyamide polyamine epichlorohydrin (trade name: ARAFIX 100, manufactured by Arakawa Kagaku Industries, Ltd.) were added, and then 0.12% of an anti-foaming agent was added (each percentage is based on the mass of the pulp).

The prepared pulp slurry was made into a sheet with a fourdrinier machine, and the sheet was dried by pressing the felt surface of the web against the drum dryer cylinder via a dryer canvas with the tensile strength of the dryer canvas set at 1.6 kg/cm. Subsequently in a size pressor polyvinyl alcohol (trade name: KL-118, manufactured by Kuraray Co., Ltd.) was applied to both the surfaces of the base paper in an amount of 1 g/m², and dried, and the sheet was calendered. The base paper was produced to have a basis weight of 166 g/m² and a thickness of 160 μm.

The wire surface (back surface) of the obtained base paper was subjected to corona discharge treatment, and coated with high-density polyethylene at a thickness of 25 μm using a melt-processing extruder to form a thermoplastic resin layer having a matte surface (hereinafter the thermoplastic resin layer surface is referred to as “back surface”). The thermoplastic resin layer on the back surface was further subjected to corona discharge treatment, and then coated with a dispersion liquid of an anti-static agent, which had been prepared by dispersing aluminum oxide (trade name: ALUMINA SOL 100, manufactured by Nissan Chemical Industries, Ltd.) and silicon dioxide (trade name: SNOWTEX O, manufactured by Nissan Chemical Industries, Ltd.) in water at a mass ratio of 1:2, to give a dry mass density of 0.2 g/m². The coating was dried, and thus a support was obtained.

### <Making of Ink Jet Recording Sheet>

### —Preparation of Ink Receiving Layer Coating Liquid A—

According to the following composition, (1) fumed silica fine particles, (2) ion exchanged water, (3) “SHAROLL DC-902P”, and (4) “ZA-30” were mixed, and dispersed using a non-media disperser (for example, an ultrasonic disperser manufactured by SMT Co., Ltd.). The dispersion liquid was heated to 45° C., and kept at the temperature for 20 hours. To the dispersion liquid, (5) boric acid, and (6) a polyvinyl alcohol solution B were added at 30° C., and thus an ink receiving layer coating liquid A was prepared.

[Composition of ink receiving layer coating liquid A]

| | |
|---|---|
| (1) Fumed silica fine particles (inorganic fine particles) | 10.0 parts |
| (trade name: AEROSIL 300SV, manufactured by | |
| Nippon Aerosil Co., Ltd.) | |
| (2) Ion exchanged water | 62.8 parts |
| (3) “SHAROLL DC-902P” (51.5% aqueous solution) | 0.87 parts |
| (dispersant, manufactured by Dai-Ichi Kogyo | |
| Seiyaku Co., Ltd.) | |
| (4) “ZA-30” (zirconyl acetate, manufactured by | 0.54 parts |
| Daiichi Kigenso Kagaku Kogyo Co., Ltd.) | |
| (5) Boric acid (crosslinking agent) | 0.44 parts |
| (6) Polyvinyl alcohol (water-soluble resin) solution B | 34.9 parts |

[Composition of polyvinyl alcohol solution B]

| | |
|---|---|
| Polyvinyl alcohol | 2.43 parts |
| (trade name: PVA235, manufactured by Kuraray Co., Ltd., | |
| degree of saponification: 88%, | |
| degree of polymerization: 3500) | |
| Polyoxyethylene lauryl ether (surfactant) | 0.03 parts |
| (trade name: EMULGEN 109P (10% aqueous solution), | |
| HLB value: 13.6 parts, | |
| manufactured by Kao Corporation) | |
| Diethylene glycol monobutyl ether | 0.74 parts |
| (trade name: BUTYCENOL 20P, manufactured by | |
| Kyowa Hakko Chemical Co., Ltd.) | |
| Ion exchanged water | 31.0 parts |

### —Preparation of Colloidal Silica Layer Coating Liquid C—

According to the following composition, (1) colloidal silica, (2) ion exchanged water, and (3) poly aluminum chloride were mixed, and dispersed using an ultrasonic disperser manufactured by SMT Co., Ltd. To the dispersion liquid, (4) a compound having an amine oxide group and (5) a polyvinyl alcohol solution were added at 30° C., and diluted with (6) ion exchanged water to give a colloidal silica concentration of 2% by mass. Thus the colloidal silica layer coating liquid C was prepared.

[Composition of colloidal silica layer coating liquid C]

| | | | |
|---|---|---|---|
| (1) | Colloidal silica (trade name: MP1040, manufactured | 173 | parts |
| | by Nissan Chemical Industries, Ltd.) | | |
| (2) | Ion exchanged water | 323 | parts |
| (3) | ALUFINE 83 | 4.6 | parts |
| | (poly aluminum chloride (cationic compound), | | |
| | manufactured by Dai-Ichi Kogyo Seiyaku Co., Ltd.) | | |
| (4) | 10% Dodecyldimethylamine oxide aqueous solution | 18 | parts |
| | (compound having an amine oxide group) | | |
| (5) | Polyvinyl alcohol (7% solution) solution | 34.9 | parts |
| | (trade name: PVA235, manufactured by Kuraray | | |
| | Co., Ltd.) | | |
| (6) | Ion exchanged water | 2700 | parts |

### —Making of Ink Jet Recording Sheet—

The front side of the support was subjected to corona discharge treatment, and then, to the support, the ink receiving layer coating liquid A and the colloidal silica layer coating liquid C were simultaneously applied in this order at coating weights of 184 ml/m² and 20 ml/m², respectively, using a slide bead coater. Immediately before the application, a 5-fold dilution of a poly aluminum chloride aqueous solution (poly aluminum chloride, trade name: ALUFINE 83, manufactured by Taimei Chemicals Co., Ltd.) was added to the ink receiving layer coating liquid to have a coating amount of 10.8 ml/m². The coating layer was dried at 80° C. with a hot air drier (wind speed: from 3 to 8 m/sec) until the solid content in the coating layer became 20%. During drying, the coating layer exhibited a constant rate drying. Before the coating layer exhibited decreasing rate drying, the coating layer was immersed in the basic solution D having the following composition for 3 seconds, and thereby 13 g/m² thereof was attached onto the coating layer, and dried at 80° C. for 10 minutes. Thus the ink jet recording sheet of Example 1 having an ink receiving layer having a dry thickness of 34 μm and a colloidal silica layer having a dry thickness of about 0.5 μm was made.

[Composition of basic solution D]

| | | |
|---|---|---|
| (1) | Boric acid | 0.65 parts |
| (2) | Ammonium carbonate (first grade; manufactured | 3.5 parts |
| | by Kanto Chemical Co., Inc.) | |
| (3) | Ion exchanged water | 63.3 parts |
| (4) | Dodecyldimethylamine oxide (2% aqueous solution) | 30.0 parts |

### Example 2

The ink jet recording sheet of Example 2 was made in the same manner as Example 1, except that the dodecyldimethylamine oxide (surfactant) in the colloidal silica layer coating liquid C and the basic solution D was replaced with myristyldimethylamine oxide.

### Example 3

The ink jet recording sheet of Example 3 was made in the same manner as Example 1, except that the dodecyldimethylamine oxide (surfactant) in the colloidal silica layer coating liquid C and the basic solution D was replaced with polyoxyethylene coconut oil alkyldimethylamine oxide.

### Example 4

The ink jet recording sheet of Example 4 was made in the same manner as Example 1, except that the dodecyldimethylamine oxide (surfactant) in the colloidal silica layer coating liquid C and the basic solution D was replaced with dihydroxyethyldodecylamine oxide.

### Comparative Example 1

The ink jet recording sheet of Comparative Example 1 was made in the same manner as Example 1, except that no colloidal silica layer was formed.

### Comparative Example 2

The ink jet recording sheet of Comparative Example 2 was made in the same manner as Example 1, except that the dodecyldimethylamine oxide (surfactant) in the colloidal silica layer coating liquid C and the basic solution D was replaced with dodecylbetaine.

### Comparative Example 3

The ink jet recording sheet of Comparative Example 3 was made in the same manner as Example 1, except that the dodecyldimethylamine oxide (surfactant) in the colloidal silica layer coating liquid C and the basic solution D was replaced with a nonionic surfactant (trade name: EMULGEN 109P, manufactured by Kao Corporation).

### Comparative Example 4

The ink jet recording sheet of Comparative Example 4 was made in the same manner as Example 1, except that no ALUFINE 83 was added in the colloidal silica layer coating liquid C.

### [Evaluation]

The ink jet recording sheets of Examples 1 to 4 and Comparative Examples 1 to 4 obtained as described above were subjected to the following evaluations.

### —Glossiness—

The glossiness of the respective ink jet recording sheets were evaluated in terms of the 60° glossiness of the sheets before printing using a digital variable angle glossmeter (trade name: UGV-6P, manufactured by Suga Test Instrument Co., Ltd.).

The acceptable glossiness is 35 or more, and more preferably 45 or more.

### —Color Formation Density (Black Density)—

Using an ink jet printer (trade name: PM-A820, manufactured by Seiko Epson Corporation) mounted with a genuine ink set, a black solid image was printed on the respective ink jet recording sheets, and dried for 24 hours at 23° C. and a relative humidity of 50%. Thereafter, the density of the solid image areas of a black color on the respective ink jet recording sheets was measured with a reflection densitometer (trade name: Xrite 310TR, manufactured by X-rite).

The acceptable density is 2.0 or more, and more preferably 2.1 or more.

### —Scratch Resistance—

Two ink jet recording sheets having no printing were stacked in such a manner that the front sides of the ink jet recording sheets (the side having the colloidal silica layer) were opposed to each other, and one of them was upward and the other downward. A 100-g weight was placed on the upper ink jet recording sheet, and the lower ink jet recording sheet was pulled out. Thereafter, scratches on the ink receiving layer of the ink jet recording sheet were visually observed. The scratch resistance of the ink jet recording sheets were evaluated according to the following criteria.
A: No scratch was observed.
B: Slight scratches were observed.
C: Apparent scratches were observed.

Table 1 lists the evaluation results of the glossiness, color formation density, and scratch resistance of the ink jet recording sheets of Example 1 to 4 and Comparative Example 1 to 4.

TABLE 1

| | | Color | Scratch |
|---|---|---|---|
| | Glossiness | formation density | resistance |
| Example 1 | 53 | 2.17 | A |
| Example 2 | 51 | 2.18 | A |
| Example 3 | 40 | 2.16 | A |
| Example 4 | 39 | 2.16 | A |
| Comparative Example 1 | 34 | 2.21 | C |
| Comparative Example 2 | 33 | 1.97 | A |
| Comparative Example 3 | 12 | 2.08 | A |
| Comparative Example 4 | 18 | 1.97 | A |

As is evident from Table 1, the ink jet recording sheets having a colloidal silica layer (Examples 1 to 4 and Comparative Examples 2 to 4) showed excellent scratch resistance. The ink jet recording sheets having a colloidal silica layer containing the cationic compound and compound having an amine oxide group according to the invention (Examples 1 to 4) showed higher glossiness and higher color formation density.

What is claimed is:

1. An ink jet recording medium comprising, on a support, at least one ink receiving layer and a colloidal silica layer containing a cationic compound and a compound having an amine oxide group in this order.

2. The ink jet recording medium of claim 1, wherein the compound having an amine oxide group is an alkylamine oxide having 10 to 24 carbon atoms.

3. The ink jet recording medium of claim 1, wherein the cationic compound is a multivalent metal salt.

4. The ink jet recording medium of claim 3, wherein the multivalent metal salt is selected from the group consisting of aluminum compounds, zirconium compounds, and titanium compounds.

5. The ink jet recording medium of claim 3, wherein the multivalent metal salt is poly aluminum chloride.

6. The ink jet recording medium of claim 1, wherein the cationic compound is a cationic polymer.

7. The ink jet recording medium of claim 1, wherein the ink receiving layer comprises particles and a water-soluble resin.
